(19) United States
(12) Patent Application Publication
(10) Pub. No.: US 2024/0077150 A1
(43) Pub. Date: Mar. 7, 2024

(54) PIPE GUIDE DEVICE

(71) Applicant: GAZTRANSPORT ET TECHNIGAZ, Saint-Rémy-Lès-Chevreuse (FR)

(72) Inventors: Cédric Felgueiras, Saint-Rémy-Lès-Chevreuse (FR); Olivier Le Gentil, Saint-Rémy-Lès-Chevreuse (FR)

(73) Assignee: GAZTRANSPORT ET TECHNIGAZ, Saint-Rémy-Lès-Chevreuse (FR)

(21) Appl. No.: 18/461,909

(22) Filed: Sep. 6, 2023

(30) Foreign Application Priority Data
Sep. 6, 2022 (FR) 2208899

(51) Int. Cl. F16L 3/01; F17C 3/02

(52) U.S. Cl. CPC F16L 3/01; F17C 3/027; F17C 2203/03; F17C 2205/0352; F17C 2223/0153; F17C 2270/0107

(57) ABSTRACT

The invention concerns a guide device (10) for a pipe intended to be moved along a first axis (X), comprising:
a support (51) comprising a receiving plate comprising a front face extending in a first plane (P1) substantially parallel to the first axis (X);
a non-stick coating film (12) fixed to the front face of the receiving plate intended to form a first line contact (13) with the pipe;
a support collar (14) having a U-shaped section having a so-called internal face (15) intended to surround the pipe, the support collar (14) being extended in a second plane (P2) substantially parallel to the first plane (P1) by two end sections (16, 17) extending on respective opposite sides of the U-shaped section;
a fixing means (18) for fixing each end section (16, 17) to the support (51);
a circular non-stick coating pad (19) fixed to the so-called internal face (15) intended to form at least one second line contact (23) with the pipe.

The present invention concerns a guide device for a pipe of circular section.

A guide device of this kind is more particularly intended to be used in a sealed and thermally-insulating tank for the transport and/or storage of liquefied gas in order to hold and to guide a spray manifold-type pipe or any other type of pipe (for example pipes of the type evacuation line, feeder line or fuel return line, radar).

Each tank wall features successively, in the direction of thickness, from the interior to the exterior of the tank, at least one sealing membrane, intended to be in contact with the fluid contained in the tank, and one thermally-insulating barrier intended to rest against a supporting structure. Alternatively, a wall may equally include two levels of sealing and of thermal insulation.

A tank generally includes at least one pipe, or spray manifold, for feeding or injecting liquefied gas into the tank. A pipe of this kind is guided along a wall by a guide assembly comprising a support fixed to the wall of the tank and a guide device intended to receive, hold and guide the pipe. The support is generally welded to the sealing membrane.

FIG. 1 represents a known prior art guide device 5. The guide device 5 is aimed at guiding a pipe which, once fitted, passes through the guide device 5. The guide device 5 for a pipe intended to be moved along a first axis X comprises a support 51 comprising a receiving plate 52 comprising a front face 53 and a rear face 54, the front face 53 extending in a first plane P1 substantially parallel to the first axis X. The guide device 5 comprises a non-stick coating film 12 extending in the first plane P1 and fixed to the front face 53 of the receiving plate 52. When the pipe (not represented) is in place in the guide device, the non-stick coating film 12 forms a first line contact with the pipe. In other words the pipe and the film 12 are tangential to a straight line segment that forms the first line contact.

The guide device 5 further comprises a support collar 4 of essentially rounded shape in order to surround the pipe of circular section. The support collar 4 is extended in a second plane P2 substantially parallel to the first plane P1 by two end portions extending at respective ends of the support collar 4. In each end portion the guide device comprises a fixing means 18 for fixing the end portion to the support 51. Finally, the guide device 5 comprises an additional non-stick coating film 12′ fixed to the internal face of the collar 4. The additional film 12′ forms a surface contact with the pipe.

The rounded shape of the support collar 4 is therefore provided so as to espouse as best as possible the circular shape of the pipe in order to ensure guiding thereof thanks to the surface contact formed between the additional film 12′ disposed against the internal face of the collar of the support and the exterior wall of the pipe.

The guide device 5 is fixed to the wall of the tank by means of the support 51. To be more precise, the non-stick coating films 12 and 12′ are retained in position between the front face of the receiving plate 52 and the internal face of the support collar 4 by means of the fixing means 18. Thus a fixing means 18 fixes an end portion of the support collar, the additional non-stick coating film 12′ and the non-stick coating film 12 together to the support 51.

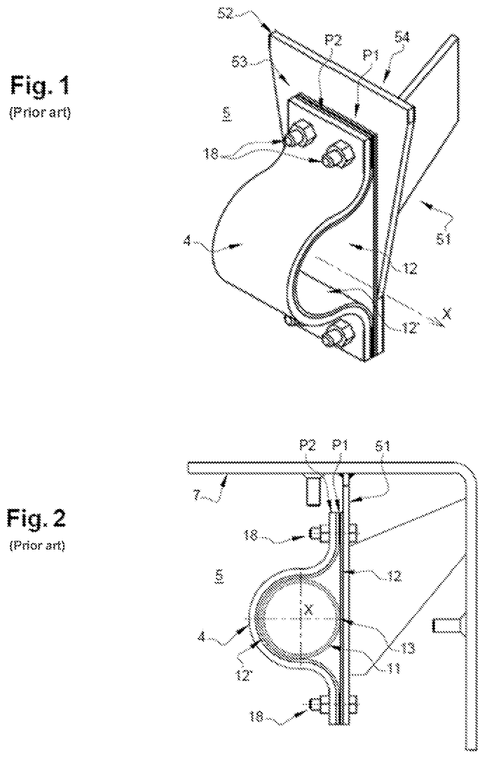

FIG. 2 represents a view of a pipe guide device 5 known from the prior art in section on a plane orthogonal to the first axis X. In this view the support 51 is fixed to a wall of the tank. To be more precise, the support 51 is welded to the sealing membrane 7. The pipe 11 is represented.

The film 12 forms the first line contact 13 with the pipe and the film 12′ forms the surface contact at the level of the exterior half-surface of the pipe 11. In other words, the film 12′ is in contact with the pipe over half an exterior portion of the pipe.

The films 12 and 12′ have an important function in the guide device. In fact, the pipe is caused to slide in the support collar, typically made of a metal such as stainless steel. The non-stick coating films 12 and 12′ allow the pipe to slide in the guide device without deterioration of either the support collar or the pipe.

As can be seen in FIG. 2 the film 12′ covers the whole of the internal face of the support collar. The support collar has a rounded shape that corresponds to the complementary shape of the pipe. The film 12′ espouses the rounded shape of the support collar. Thus the pipe is guided and held in position in the support collar whilst guaranteeing that friction between the pipe and the guide device is reduced to the minimum.

Although satisfactory overall, this solution has a disadvantage: In the absence of functional clearance between the films 12 and 12′ and the pipe, generally linked to a mounting error, the friction is too high. Now, the pipe is moved in the guide device, contracts at low temperature and expands at high temperature. Because of the too high friction and the repetitive movements of the pipe in its guide device, the non-stick coating films that are overall too thin to resist this are damaged. The latter, fixed only at their ends at the level of the end portions of the support collar by the fixing means 18, can then break and escape from the support collar. This results in a faulty guide device that is no longer able to provide the sliding function for the pipe correctly.

A solution once envisaged for solving this problem could be fixing the film 12′ to the internal face of the support collar, in particular by gluing it thereto. However, the Applicant is of the opinion that a solution of this kind is to be avoided. In fact, the non-stick coating film 12′ (typically made of polytetrafluoroethylene, also known as PTFE or by its trade name Teflon®) has a coefficient of expansion higher than that of the support collar (typically made of stainless steel). It is therefore preferable for the film 12′ to remain free to prevent any stress on the film 12′ that would then risk breaking.

The invention aims to alleviate some of or all of the problems cited above by proposing a new guide device that is robust, easy to mount, and enables easy checking of the positioning of the non-stick coating. Moreover, the guide device according to the invention makes it possible to limit the friction while reducing the risk of the non-stick coating breaking.

To this end, the invention has for object a guide device for a pipe intended to be moved along a first axis, the guide device being characterised in that it comprises:
a support comprising a receiving plate comprising a front face and a rear face, the front face extending in a first plane substantially parallel to the first axis;
a non-stick coating film fixed to the front face of the receiving plate intended to form a first line contact with the pipe;
a support collar having a U-shaped section having a so-called internal face intended to surround the pipe, the support collar being extended in a second plane substantially parallel to the first plane by two end sections extending on respective opposite sides of the U-shaped section;
for each end section: a fixing means for fixing the end section to the support;
at least one circular non-stick coating pad fixed to the so-called internal face of the U-shaped section intended to form at least one second line contact with the pipe.

In one embodiment of the guide device according to the invention the at least one circular non-stick coating pad is fixed to the so-called internal face of the U-shaped section by a fixing means disposed at the centre of said at least one circular non-stick coating pad.

Advantageously, the non-stick coating is a fluoropolymer, preferably polytetrafluoroethylene.

Advantageously, the U-shaped section comprises a central portion at a distance from the first plane and substantially parallel to the first plane and two lateral portions extending on respective opposite sides of the central portion as far as the one and the other of the end sections.

In one embodiment of the guide device according to the invention each of the two lateral portions forms an obtuse angle with central portion.

In another embodiment of the guide device according to the invention each of the two lateral portions forms a right angle with the central portion.

The invention also concerns a guide assembly for a pipe intended to extend in a tank, the guide assembly being characterised in that it comprises a guide device and a fixing tab connected to the rear face of the receiving plate, the fixing tab being intended to be connected to a wall of the tank.

The invention also relates to a wall for a sealed and thermally-insulating tank for storing a liquefied gas, the wall including successively in a direction of thickness from the exterior to the interior:
at least one thermally-insulating panel intended to rest directly or indirectly against a supporting structure,
a sealing membrane that rests against the at least one thermally-insulating panel and is intended to be in contact with the liquefied gas contained in the tank,
a guide assembly, the fixing tab being welded to the sealing membrane, for a pipe intended to introduce the liquefied gas into the tank.

The invention also concerns a sealed and thermally-insulating tank of a ship intended to contain a liquefied gas and comprising one such wall.

The invention also concerns a ship including a hull forming a supporting structure and a tank of the above kind anchored on said supporting structure.

Moreover, the guide device according to the invention may have one or more of the following features, separately or in combination.

The aspects of the invention described may include one or more examples, embodiments or features separately or in diverse combinations, whether specifically stated or not (including claimed) in that combination or separately.

These features and advantages and others of the present invention will become more clearly apparent on the basis of the following description given with reference to the appended drawings provided by way of non-limiting example and in which:

FIG. 1 represents a pipe guide device known from the prior art;

FIG. 2 represents a view in section of a pipe guide device known from the prior art;

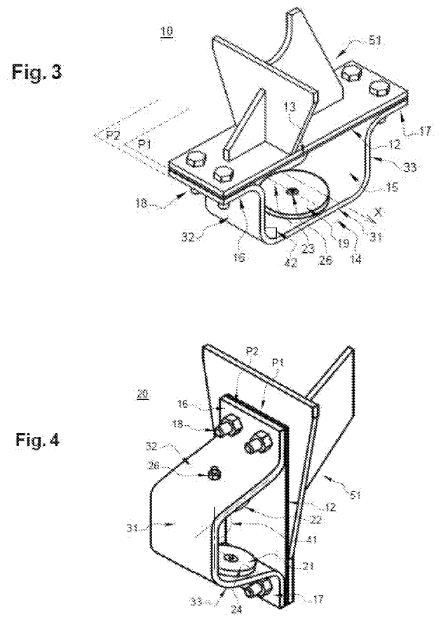

FIG. 3 represents a first embodiment of a guide device according to the invention;

FIG. 4 represents a second embodiment of a guide device according to the invention;

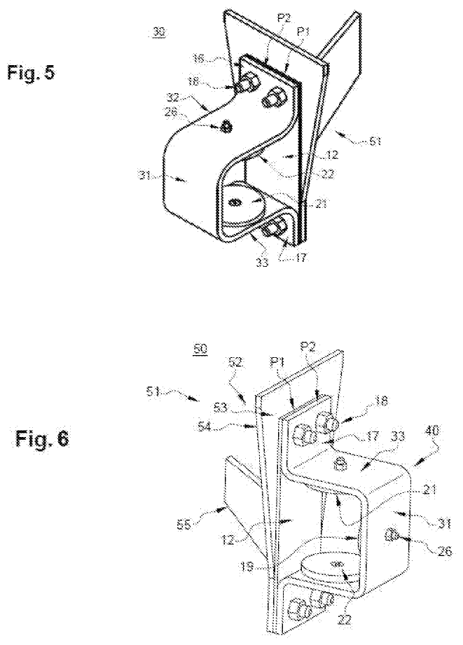

FIG. 5 represents a third embodiment of a guide device according to the invention;

FIG. 6 represents a guide assembly according to the invention comprising a fourth embodiment of a guide device according to the invention;

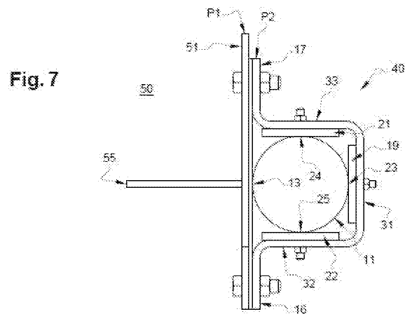

FIG. 7 represents a profile view of the guide assembly according to the invention.

For clarity the same elements bear the same references in the various figures.

FIG. 1 represents a pipe guide device known from the prior art. This figure has already been described hereinabove.

FIG. 2 represents a view in section of a pipe guide device known from the prior art and has already been described hereinabove.

FIG. 3 represents a first embodiment of a pipe guide device 10 according to the invention. A guide device of this kind being more particularly intended to be used in a sealed and thermally-insulating tank for the transport and/or storage of liquefied gas, it is subjected to wide temperature variations. As a result of this the pipe contracts at low temperature and expands at high temperature. The pipe therefore moves in translation in its guide device. The guide device 10 for a pipe 11 (not represented) intended to be moved along a first axis X comprises a support 51 comprising a receiving plate 52 comprising a front face 53 and a rear face 54, the front face 53 extending in a first plane P1 substantially parallel to the first axis X. The guide device 10 comprises a non-stick coating film 12 fixed to the front face 53 of the receiving plate 52, the non-stick coating film 12 being intended to form a first line contact 13 with the pipe 11. The pipe generally being of circular section, the pipe and the non-stick coating film 12 are tangential to the straight line segment 13 (parallel to the first axis X).

The guide device 10 comprises a support collar 14 consisting of a U-shaped section (or U-shaped zone) having a so-called internal face 15 intended to surround the pipe. The support collar 14 is extended in a second plane P2 substantially parallel to the first plane P1 by two end sections (or end portions) 16, 17 extending on respective opposite sides of the U-shaped section. For the support collar 14 the terms section, zone and portion define parts of the support collar, as can be seen in the figures.

By U-shaped must be understood a shape with a central portion 31 at a distance from the first plane P1 and substantially parallel to the plane P1 and two lateral portions 32, 33 each extending in a plane intersecting the central portion 31 on respective opposite sides of the central portion 31 as far as one and the other end portion 16, 17.

In the embodiment shown in FIG. 3 each of the two lateral portions 32, 33 forms a right angle 42 with the central portion 31.

For each end portion 16, 17 the guide device 10 comprises a fixing means 18 for fixing the end portion 16, 17 to the support 51. The fixing means 18 may be a nut-and-bolt assembly or a rivet or any other appropriate fixing means. Moreover, the fixing means 18 may be two nut-and-bolt assemblies or two rivets.

In accordance with the invention the guide device 10 comprises a circular non-stick coating pad 19 fixed to the so-called internal face 15 of the U-shaped section, intended to form a second line contact 23 with the pipe. As is clearly apparent in the figures, the internal face 15 corresponds to the surface of the support collar disposed facing the non-stick coating film 12. The circular pad 19 is fixed to the support collar by a fixing means 26, for example a screw or a rivet. By circular pad must be understood a pad of circular shape. That is to say has a circular section in the plane in which it extends (in other words, a plane locally parallel to the portion (central portion 31 or lateral portion 32, 33) to which it is fixed). By way of non-limiting example the circular pad may have a diameter of the order of 60 or 80 mm and a thickness of 5 mm. Obviously, the dimensions of the circular pad are adapted as a function of the dimensions of the pipe and of the support collar. The diameter of the circular pad is preferably equal to the width of the so-called internal face 15 of the support collar 14.

In the context of the invention and by way of non-limiting example the non-stick coating may be made of a fluoropolymer, preferably of polytetrafluoroethylene (PTFE, better known under the trade name Teflon®), or perfluoroalkoxy (PFA), or fluoroethylene propylene (FEP).

Thanks to these features the guide device 10 enables retention of the pipe whilst allowing it to be guided on sliding through the support collar because of the two line contacts 13, 23. The support collar 14 is sized so that the distance between the two segments 13 and 23 corresponds to the outside diameter of the pipe (typically of the order of 60 mm), with a tolerance of a few millimetres (typically between 0.5 and 3 mm for a pipe of this kind) in order to enable sliding.

The non-stick coating pad 19 is preferably fixed to the so-called internal face 15 of the U-shaped zone by a fixing means 26 disposed at the centre of said at least one non-stick coating pad 19. Moreover, the pad being of circular shape, the pad is totally symmetrical around the fixing means. These features make it possible to obtain a robust guide device because of the fixed circular pad of controlled thickness. Moreover, the positioning of the pads is assured and the clearance between the pad and the pipe (defined as between 0.5 and 3 mm) is easy to control thanks to the line contact.

As mentioned above the fixing means 26 may be a screw or a rivet. The pad has a passage channel through it enabling the passage of the fixing means. Moreover, the passage channel comprises on the upper surface of the pad an opening configured to receive the head of the fixing means 26 (rivet head or screw head), so that the head does not project from the pad. In other words, the passage channel in the pad ensures that there is no protrusion of the fixing means 26 beyond its upper surface. The pipe therefore comes into line contact with the pad.

Thanks to these features the pad has only one point of attachment to the support collar. This avoids the problems of thermal contraction when the tank is cooling down because the contraction occurs in a symmetrical manner about the only point of attachment of the pad on the support collar.

Although the pipe is generally of circular section, the particular feature of the invention is based on the combination of a U-shaped support collar with portions at an angle to one another (that is to say of non-rounded overall shape) with circular non-stick pads. In other words, the or each guide device known from the prior art favours the area of contact between the support collar and the pipe in order to produce the pipe guide function and to allow sliding of the pipe in the collar, but the guide device according to the invention is innovative in that it aims to reduce this area of contact while guaranteeing good guiding and sliding of the pipe. The circular pads assure less friction on a line contact than on a surface contact. The guide device according to the invention guarantees both its function of guiding the pipe and the possibility of the pipe sliding during its contraction/extension.

In the embodiment shown in FIG. 3 the central portion 31 is wider than the lateral portions 32, 33 are high. This configuration of the support collar 14 allows a free space that offers the pipe a degree of freedom in translation along an axis parallel to the first plane P1. In other words, in addition to tolerating sliding along the axis X, movement in translation of the pipe in the support collar perpendicularly to the axis X is also made possible. This degree of freedom in translation, necessary to positioning the pipe when cold because of thermal contraction, enables adaptation of the positioning of the pipe along a wall of the tank, according to the positioning configuration of the guide device in the tank.

Note that this degree of freedom in translation is optional. In another embodiment the central portion 31 may be as wide as the lateral portions 32, 33 are high. In this configuration the pipe 11 has only the possibility of sliding along the first axis X.

FIG. 4 represents a second embodiment of a guide device 20 according to the invention. The guide device 20 comprises the same elements as the guide device 10. In this embodiment of the invention each of the two lateral portions 32, 33 forms an obtuse angle 41 with the central portion 31. By way of non-limiting example the angle 41 may be of the order of 120°.

Moreover, the guide device 20 comprises two circular non-stick coating pads 21, 22 fixed to the so-called internal face of the collar 14, respectively at the level of the lateral portion 33 and the lateral portion 32. In this configuration the two circular non-stick coating pads 21, 22 fixed to the so-called internal face 15 of the U-shaped zone are intended to form two line contacts 24, 25 with the pipe (the line contact 25 is not represented). The two line contacts 24, 25 and the first line contact 13 guarantee three contact segments between the pipe and the guide device by way of the non-stick coating. Once again, the correct dimensions of the support collar and the thickness of the pads make it possible to reduce the area of contact between the guide device and the pipe while assuring the sliding function necessary for the guide device of the spray manifold to function. Moreover, positioning the two non-stick coating pads 21, 22 on either side of the pipe enables vertical immobilisation of the pipe, that is to say there is no movement in translation of the pipe along the axis perpendicular to the first axis X that extends parallel to the first plane P1. The judicious positioning of the pads 21, 22 therefore guarantees the possibility of the pipe sliding along the first axis X while immobilising the pipe perpendicular to that axis X.

FIG. 5 represents a third embodiment of a guide device 30 according to the invention. The guide device 30 comprises the same elements as the guide device 20. In this embodiment of the invention each of the two lateral portions 32, 33 forms a right angle with the central portion 31. Just like the guide device 20, in the guide device 30 the two non-stick coating pads 21, 22 are fixed to the so-called internal face of the collar 14, respectively at the level of the lateral portion 33 and of the lateral portion 32.

It may be noted that in the configuration shown in FIG. 5 (a circular pad fixed to each of the lateral portions 32, 33) there is no departure from the scope of the invention whatever the shape of the central portion 31. The latter may be plane as represented in FIG. 5 or could assume a more rounded shape (for example in the form a half-cylinder adjoining the lateral portions).

In this variant embodiment the distance between the central portion 31 and the non-stick coating film 12 may be greater than the outside diameter of the pipe, by of the order of several millimetres, for example 9 mm. This configuration of the support collar 14 enables the provision of a free space that offers the pipe a degree of freedom in translation along an axis perpendicular to the first plane P1. In other words, in addition to tolerating sliding along the axis X, movement in translation of the pipe in the support collar perpendicularly to the axis X is also made possible. This degree of freedom in translation makes it possible to adapt the positioning of the pipe along a wall of the tank. It is a necessary additional degree of freedom at low temperature because of thermal contraction. This kind of additional degree of freedom is necessary in some guide devices uniquely as a function of their position relative to anchor points of the pipes in the tank.

FIG. 6 represents a guide assembly 50 in accordance with the invention comprising a fourth embodiment of a guide device 40 according to the invention. The guide device 40 comprises the same elements as the guide device 20. In this embodiment of the invention each of the two lateral portions 32, 33 forms a right angle with the central portion 31. Just like the guide device 20, in the guide device 40 the two non-stick coating pads 21, 22 are fixed to the so-called internal face of the collar 14, respectively at the level of the lateral portion 33 and of the lateral portion 32. The guide device 40 further comprises a non-stick coating pad 19 at the level of the so-called internal face of the central portion 31 of the support collar.

The guide assembly 50 comprises the guide device 40 and a fixing tab 55 connected to the rear face 54 of the receiving plate 52, the fixing tab 55 being intended to be connected directly or indirectly to a wall of the tank. Note that in the context of the invention the guide assembly may comprise any other guide device 10, 20, 30 as described above.

The receiving plate is also intended to be fixed to the wall of the tank. The fixing tab constitutes a reinforcement for the receiving plate 52.

FIG. 7 represents a profile view of the guide assembly 50 according to the invention. There can in particular be seen therein the line contacts 13, 23, 24, 25 in the other embodiments of the guide device according to the invention described above.

Thanks to the invention it is possible to consider only one design of non-stick coating pad regardless of the shape of the support collar.

Moreover, fixing circular pads makes it possible to control the functional clearance between the non-stick coating and the pipe. This results in a reduction of the risk of the non-stick coating breaking.

Fixing circular pads also makes it possible to reduce the areas of contact between the pipe and the guide device. This reduction of the non-stick coating area contributes to limiting the friction between the pipe and the guide device. This also results in a reduction of the risk of the non-stick coating breaking.

The invention also relates to a wall for a sealed and thermally insulating tank for storing a liquefied gas, the wall comprising successively in a direction of thickness from the exterior to the interior:
at least one thermally insulating panel intended to rest directly or indirectly against a supporting structure,
a sealing membrane 7 which rests against the at least one thermally insulating panel and is intended to be in contact with the liquefied gas contained in the tank,
a guide assembly 50, the fixing tab being welded to the sealing membrane 7, for a pipe 11 intended to introduce the liquefied gas into the tank.

The invention also concerns a sealed and thermally insulating tank of a ship intended to contain a liquefied gas and comprising at least one such wall.

Finally, the invention also relates to a ship comprising a hull forming a supporting structure and a tank as described above anchored on said supporting structure.

It will be more generally apparent to the person skilled in the art that various modifications can be made to the embodiments described hereinabove, in the light of the teaching which has just been disclosed to them. In the following claims, the terms used should not be interpreted as limiting the claims to the embodiments disclosed in the present description, but should be interpreted to include all the equivalents which the claims are intended to cover by virtue of their formulation and predicting which is within the skill of the person skilled in the art based on their background knowledge.

1. A guide device for a pipe configured to be moved along a first axis, the guide device comprising:
a support comprising a receiving plate comprising a front face and a rear face, the front face extending in a first plane substantially parallel to the first axis;
a non-stick coating film fixed to the front face of the receiving plate configured to form a first line contact with the pipe;
a support collar having a U-shaped section having a so-called internal face intended to surround the pipe, the support collar being extended in a second plane substantially parallel to the first plane by two end sections extending on respective opposite sides of the U-shaped section;
for each end section, a fixing means for fixing the end section to the support; and
at least one circular non-stick coating pad fixed to the so-called internal face of the U-shaped section configured to form at least one second line contact with the pipe.

2. The guide device according to claim 1, in which the at least one circular non-stick coating pad is fixed to the so-called internal face of the U-shaped section by a fixing means disposed at the centre of said at least one circular non-stick coating pad.

3. The guide device according to claim 1, in which the non-stick coating is a polytetrafluoroethylene.

4. The guide device according to claim 1, in which the U-shaped section comprises a central portion at a distance from the first plane and substantially parallel to the first plane and two lateral portions extending on respective opposite sides of the central portion as far as the one and the other of the end sections.

5. The guide device according to claim 4, in which each of the two lateral portions forms an obtuse angle with central portion.

6. The guide device according to claim 4, in which each of the two lateral portions forms a right angle with the central portion.

7. A guide assembly for a pipe configured to extend in a tank, the guide assembly comprising:
a guide device according to claim 1; and
a fixing tab connected to the rear face of the receiving plate, the fixing tab being configured to be connected to a wall of the tank.

8. A wall for a sealed and thermally-insulating tank for storing a liquefied gas, the wall including successively in a direction of thickness from the exterior to the interior:
at least one thermally-insulating panel configured to rest directly or indirectly against a supporting structure;
a sealing membrane that rests against the at least one thermally-insulating panel and is configured to be in contact with the liquefied gas contained in the tank; and
a guide assembly as claimed in claim 7, the fixing tab being welded to the sealing membrane, for a pipe configured to introduce the liquefied gas into the tank.

9. A sealed and thermally-insulating tank of a ship that contains a liquefied gas comprising at least one wall according to claim 8.

10. A ship comprising: a hull forming a supporting structures and a tank according to claim 9 anchored on said supporting structure.
